(19) United States
(12) Patent Application Publication
(10) Pub. No.: US 2009/0247219 A1
(43) Pub. Date: Oct. 1, 2009

(54) METHOD OF GENERATING A FUNCTION OUTPUT FROM A PHOTOGRAPHED IMAGE AND RELATED MOBILE COMPUTING DEVICE

(76) Inventors: Jian-Liang Lin, Taoyuan County (TW); John C. Wang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/055,285

(22) Filed: Mar. 25, 2008

(51) Int. Cl. H04M 1/03

(52) U.S. Cl. 455/556.1

(57) ABSTRACT

To perform a search, or other function, based on input from a camera in a mobile computing device, the camera of the mobile computing device captures an image, an area corresponding to text or another searchable object in the image is selected or determined, the text in the area is recognized to generate a plurality of characters, or a string, the plurality of characters or the object becomes input for the function, and output of the function is displayed in a display of the mobile computing device.

### BACKGROUND OF THE INVENTION

1. Field of the Invention

The present invention relates to methods of performing searches, and more particularly, to a method of utilizing a photographed image in a mobile computing device for performing a search.

2. Description of the Prior Art

Mobile computing devices, such as personal data assistants (PDAs) and smartphones, are attractive to consumers because they provide telephone, e-mail, and personal organization functionality, are free of power cords and network cables, and are small enough to fit in the palm of your hand. Mobile devices also digitally enhance functions, e.g. schedulers, contact lists, and notepads that may originally have been confined to pen and paper. Alarms can be set to remind the user of scheduled events. And, even further search and data integration functionality can be provided through connections to external networks, such as the Internet.

That being said, mobile devices have one very frustrating disadvantage when compared to computers and personal organizers, which is a product of the very characteristic that makes them so attractive, namely their size. Due to the relatively small size of mobile devices, text input is normally a task fraught with frustration. A number of input devices are employed in mobile devices, including keypads (hardware or software), number pads (hardware or software), or styluses. Keypads are typically a miniaturized keyboard, which fits on the mobile computing device, or a software keyboard displayed on a touch screen of the mobile computing device, which may be utilized with the stylus or fingers to input text in a manner similar to the miniaturized keyboard. Number pads typically have 12 keys, and thus allow text input by multiple keystrokes. Styluses are utilized with touch-sensitive devices, and typically employ a simplified form of handwriting. It is very common that a wrong keystroke will be made when typing with keypads, leading to extra keystrokes required to correct the mistake. As mentioned, number pads require extra keystrokes to make up for their limited number of keys. And, when using a stylus, the user's hand may easily tire due to the small size of the stylus, and the fine motions required for the mobile computing device to recognize the text being inputted. Thus, text input in mobile computing devices is currently unable to achieve the speed and accuracy provided by the conventional keyboard.

### SUMMARY OF THE INVENTION

According to a preferred embodiment of the present invention, a method of displaying an output of a function utilized in a mobile computing device comprises utilizing a camera device of the mobile computing device to capture an image, determining an area corresponding to text in the image, the mobile computing device recognizing text in the image to generate a plurality of characters, the mobile computing device inputting the plurality of characters to the function, and displaying the output of the function in the mobile computing device.

According to another embodiment of the present invention, a mobile computing device for displaying an output of a function comprises a memory storing digital image data and image search program code, a display for displaying graphical representations of text data and image data, and a processor coupled to the memory and the display for executing the image search program code to select the digital image data, determine a corresponding region of the digital image data, recognize text in the corresponding region to generate at least one string, input the at least one string to the function for generating the output, and control the display to display the output of the function.

According to a second embodiment of the present invention, a method of generating an output of a function utilized in a mobile computing device comprises selecting an image in the mobile computing device, the mobile computing device recognizing an object in the image to generate an input for the function, and displaying the output of the function generated based on the input in the mobile computing device.

According to another embodiment of the present invention, a mobile computing device for generating an output of a function comprises a processor for selecting an image in the mobile computing device, and recognizing an object in the image as an input to the function, and a display coupled to the processor for displaying the output of the function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method of displaying an output of a function according to the present invention.

FIG. 2 is a diagram of a mobile computing device photographing text.

FIG. 3 is a diagram of the mobile computing device displaying database search results according to the photographed text.

FIG. 4 is a diagram of a method of generating an output of a function according to the present invention.

FIG. 5 is a function block diagram of the mobile computing device according to the present invention.

FIG. 6 is a diagram of the mobile computing device photographing an object.

### DETAILED DESCRIPTION

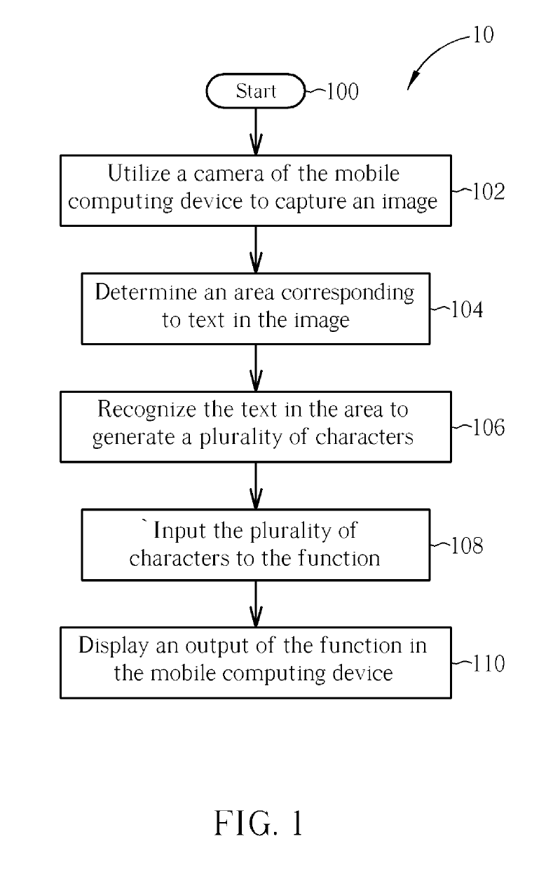

Please refer to FIG. 1, which is a flowchart of a process 10 for displaying an output of a function in a mobile computing device according to the present invention. The process 10 comprises the following steps:

Step 100: Start.

Step 102: Utilize a camera of the mobile computing device to capture an image.

Step 104: Determine an area corresponding to text in the image.

Step 106: Recognize the text in the area to generate a plurality of characters.

Step 108: Input the plurality of characters to the function.

Step 110: Display an output of the function in the mobile computing device.

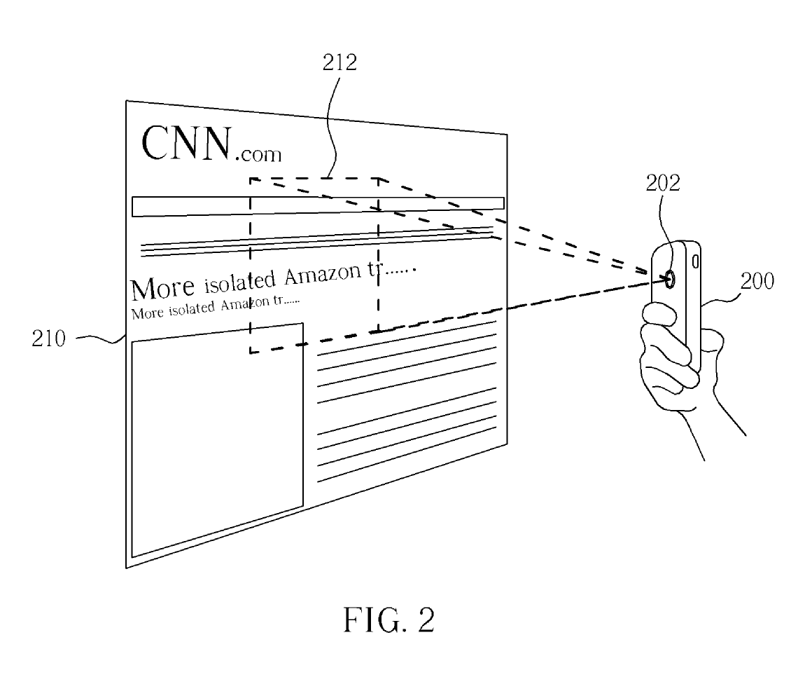

In the present invention, the mobile computing device may utilize a camera device to capture an image (Step 102). Please refer to FIG. 2, which shows a user using a camera device 202 of the mobile computing device 200 to capture an image. The mobile computing device 200 is preferably a smartphone, PDA phone or touch phone, but could also be another networked device with an integrated camera device, such as a PDA or notebook. As shown in FIG. 2, the user may browse a web page 210 (in this case, CNN.com), and the user may utilize the camera device 202 of the mobile computing device 200 to photograph a section 212 of the web page 210. The user may also select a stored image stored as digital image data in a memory of the mobile computing device instead of utilizing the camera device 202 to capture the image. This would allow the user to capture the image first, then perform further processing at a later time. The user could also browse a publication, such as a book, newspaper or magazine, and utilize the camera device 202 of the mobile computing device 200 to photograph a page or region of the publication. The user may be interested in searching for information on an object appearing in the page or region of the publication, something on a front page of the publication, or an advertisement, such as an advertisement for a consumer product. The object may also be an actor/actress, or even a logo.

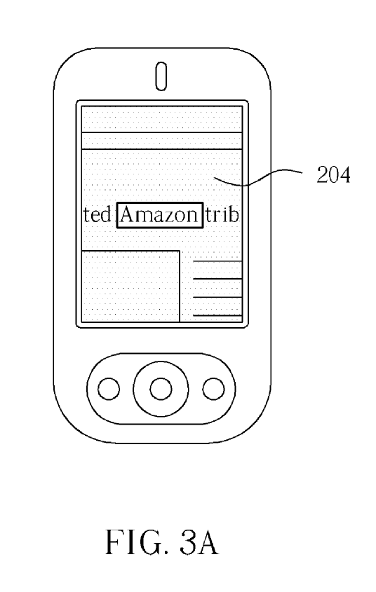

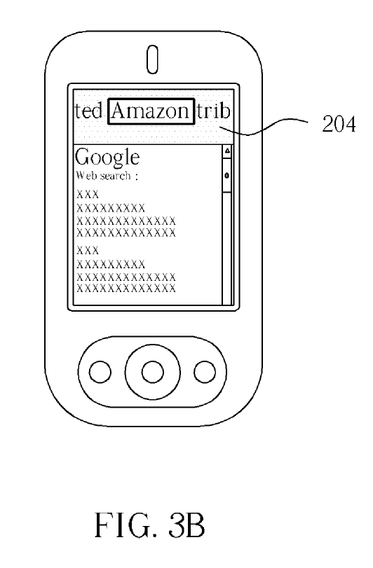

Please refer to FIGS. 3A and 3B, which show a display 204 of the mobile computing device 200 as the user selects text in the image for performing a search (Step 104). As shown in FIG. 3A, the user may select the word “Amazon” (Step 104). Then, the word “Amazon” may be converted from pixels in the image to a character string that may be inputted to the Google search engine (Steps 106-108). Results sent back to the mobile computing device 200 from the Google search engine are then displayed in the display 204 of the mobile computing device 200 (FIG. 3B, Step 110). Of course, the function could be one of many online or offline functions, including a search engine, a dictionary, a map, and a retailer data comparison, etc. The Google search engine is used as an example, and any Google search function, Yahoo! search function, or other database search function may be utilized as the function in the present invention. Database comparison functions may also be utilized as the function in the present invention.

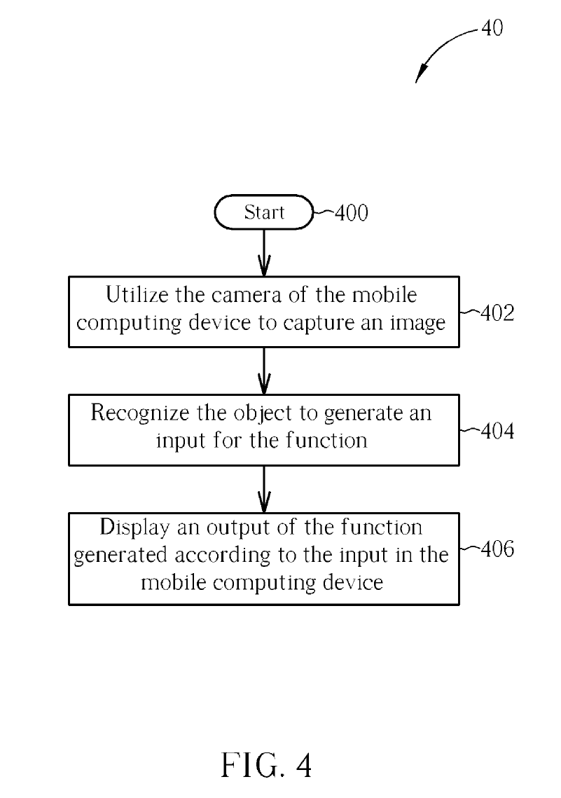

Please refer to FIG. 4, which is a diagram of a process 40 according to a second embodiment of the method of displaying the output of the function. The process 40 comprises the following steps:

Step 400: Start.

Step 402: Utilize the camera of the mobile computing device to capture an image.

Step 404: Recognize the object to generate an input for the function.

Step 406: Display an output of the function generated according to the input in the mobile computing device.

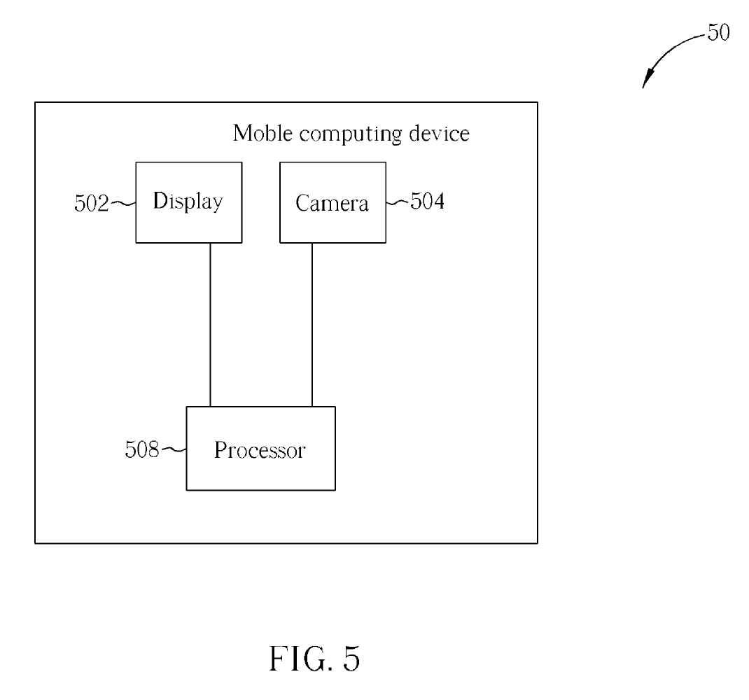

Please refer to FIG. 5, which is a diagram of a mobile computing device 50 according to the present invention. The mobile computing device 50 can be seen as the mobile computing device 200 in the above description, and comprises a display 502, a camera 504, and a processor 408 coupled to the display 502 and the camera 504. The memory may include the digital image data, such as the image mentioned above. The above-mentioned process 10 or the process 40 may also be stored in the memory as image search program code, which the processor 508 may execute for selecting the digital image data, determining the corresponding region of the digital image data, recognizing the text in the corresponding region to generate the at least one string, inputting the at least one string to the function for generating the output, and controlling the display 502 to display the output of the function. The camera 504, or camera device, may be utilized to capture the image mentioned above, and store the image in the memory as the digital image data. The display may be utilized for displaying graphical representations of text data or image data, such as the digital image data mentioned above, e.g. by manipulating light to display a plurality of display pixels having different chroma and luminance levels.

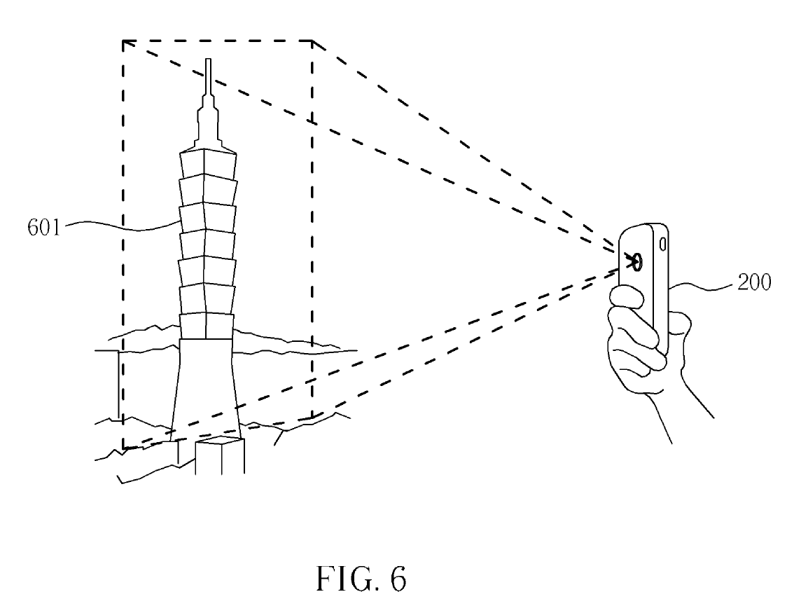

In the second embodiment of the present invention, the mobile computing device may use the camera 504 to capture an image (Step 502). Please refer to FIG. 6, which shows a user using the mobile computing device 50 to capture an image. As shown in FIG. 6, for example, the user may photograph an object 601, such as the Taipei 101 Building. Based on an image of the Taipei 101 Building captured by the mobile computing device 50, the mobile computing device may then perform a search to find information about the Taipei 101 Building. The user may be interested in searching for information on other objects appearing in the publication, e.g. something on a front page of the publication, or an advertisement, such as an advertisement for a consumer product. The object 601 may also be a representation of an actor/actress, or even a logo. In other words, the present invention does not place any limitations on type of the object 601 or image source. The object 601 could even be a physical object, such as a plant, animal, or car that the user photographs with the camera 504 of the mobile computing device 50. Once the object 601 is captured in digital image data, and recognized by the mobile computing device 50, a database search or comparison function may be utilized as the function to gain more information about the object 601. For example, the Google search engine may be used as the function. Or, any other Google search function, Yahoo! search function, or other database search function may be utilized as the function of the present invention as well. If the function is available for access on a remote server, such as the Google search function, the mobile computing device 50 may further comprise a network interface, such as a wired network interface or a wireless network interface, for sending the input to the function through a network and/or receiving the output of the function through the network. A Wi-Fi, HSDPA, WIMAX, or a GPRS communications protocol may also be utilized as the network interface.

Compared to the prior art, the present invention allows a user to photograph an image with text or an object, and the mobile computing device recognizes the text or the object within the image (or within a selected area of the image). The user can then select desired text from the image using the input device of the mobile computing device, and the mobile computing device can then input the desired text or the object to a desired function. The output of the desired function is then displayed on the mobile computing device. This gives the user a quick, intuitive method of looking up text or one object on a search engine, in a dictionary, on a map, or in a retailer data comparison application, without having to input the text or text related to the object manually using the cumbersome input devices of the prior art.

Those skilled in the art will readily observe that numerous modifications and alterations of the device and method may be made while retaining the teachings of the invention.

What is claimed is:

1. A method of displaying an output of a function utilized in a mobile computing device comprising:
selecting an image in the mobile computing device;
determining an area corresponding to text in the image;
the mobile computing device recognizing text in the image to generate a plurality of characters;
the mobile computing device inputting the plurality of characters to the function; and
displaying the output of the function in the mobile computing device.

2. The method of claim 1, wherein the image is a camera image captured by a camera device of the mobile computing device.

3. The method of claim 1 further comprising the mobile computing device sending the plurality of characters to the function through a network or the mobile computing device receiving the output of the function through the network.

4. The method of claim 1, wherein the function is a database search function.

5. The method of claim 3, wherein the database search function is a Google search function, a Yahoo! search function, or a dictionary search function.

6. The method of claim 1, wherein the function is a data comparison function.

7. The method of claim 1, wherein the mobile computing device is a smart phone, a PDA, a PDA phone, or a touch phone.

8. A mobile computing device for displaying an output of a function, the mobile computing device comprising:
a memory storing digital image data and search program code;
a display for displaying graphical representations of text data and image data; and
a processor coupled to the memory and the display for executing the search program code to select the digital image data, determine a corresponding region of the digital image data, recognize text in the corresponding region to generate at least one string, input the at least one string to the function for generating the output, and control the display to display the output of the function.

9. The mobile computing device of claim 7, further comprising a camera device coupled to the processor for capturing a digital image for storage as the digital image data.

10. The mobile computing device of claim 7, further comprising a network interface coupled to the processor for sending the at least one string to the function or receiving the output of the function through a data connection established between the network interface and a server.

11. The mobile computing device of claim 7, wherein the function is a database search function.

12. The mobile computing device of claim 10, wherein the database search function is a Google search function, a Yahoo! search function, or a dictionary search function.

13. The mobile computing device of claim 7, wherein the function is a data comparison function.

14. A method of generating an output of a function utilized in a mobile computing device comprising:
selecting an image in the mobile computing device;
the mobile computing device recognizing an object in the image to generate an input for the function; and
displaying the output of the function generated based on the input in the mobile computing device.

15. The method of claim 13, wherein the image is a camera image captured by a camera device of the mobile computing device.

16. The method of claim 13, further comprising the mobile computing device sending the input to the function through a network or the mobile computing device receiving the output of the function through the network.

17. The method of claim 13, wherein the function is a database search function.

18. The method of claim 16, wherein the database search function is a Google search function, a Yahoo! search function, or a dictionary search function.

19. The method of claim 13, wherein the function is a data comparison function.

20. A mobile computing device for generating an output of a function, the mobile computing device comprising:
a processor for selecting an image in the mobile computing device, and recognizing an object in the image as an input to the function; and
a display coupled to the processor for displaying the output of the function.

21. The mobile computing device of claim 19, further comprising a camera device for capturing the image.

22. The mobile computing device of claim 19, further comprising a network interface for sending the input to the function through a network, or for receiving the output of the function through the network.

23. The mobile computing device of claim 19, wherein the function is a database search function.

24. The mobile computing device of claim 22, wherein the database search function is a Google search function, a Yahoo! search function, or a dictionary search function.

25. The mobile computing device of claim 19, wherein the function is a data comparison function.
